(19) United States
(12) Patent Application Publication
(10) Pub. No.: US 2017/0154290 A1
(43) Pub. Date: Jun. 1, 2017

(54) INTERREGIONAL SUPPLY ADJUSTMENT DEVICE AND PROGRAM

(71) Applicant: HITACHI, LTD., Chiyoda-ku, Tokyo (JP)

(72) Inventors: Tazu NOMOTO, Tokyo (JP); Masayasu UOZAKI, Tokyo (JP); Keiji MATSUMOTO, Tokyo (JP)

(21) Appl. No.: 15/312,941

(22) PCT Filed: Nov. 21, 2014
(86) PCT No.: PCT/JP2014/080842

§ 371 Date: Nov. 21, 2016

(30) Foreign Application Priority Data
May 26, 2014 (JP) 2014-107690

(51) Int. Cl. G06Q 10/06; G06Q 10/08

(52) U.S. Cl. CPC G06Q 10/06315; G06Q 10/087

(57) ABSTRACT

The objective of the present invention is to reduce the calculation time in an interregional supply adjustment plan. This interregional supply adjustment device is characterized by being equipped with a storage unit that stores, for each commodity in each region, a supply amount (which includes a production amount, an inventory amount, and a goods-in-process amount), and a sales plan amount, and that stores adjustment authorization information indicating a second region that has been authorized to perform a supply adjustment with respect to a first region when a commodity deficiency occurs in the sales plan in the first region, with the interregional supply adjustment device having: a first function, whereby the supply amount and the sales plan amount in the first region are obtained from the storage unit, and the amount of the deficiency for a deficient commodity for which the supply amount does not satisfy the sales plan amount is identified; a second function, whereby a second region is identified with respect to the deficient commodity, from the storage unit; and a third function, whereby supply adjustment information (which includes the commodity for which the supply is to be adjusted from the second region to the first region, and the amount of the supply adjustment) is generated, on the basis of the excess amount in the second region and the production amount, the inventory amount, and the goods-in-process amount in the first region.

### TECHNICAL FIELD

The present invention relates to an interregional supply adjustment technique for planning supply adjustment among regions.

### BACKGROUND ART

PATENT LITERATURE 1 relating to production adjustment and production/stock adjustment in a region exists as a background art relating to supply adjustment planning.

### CITATION LIST

### Patent Literature

### PATENT LITERATURE 1: JP-A-2013-196381

### PATENT LITERATURE 2: JP-A-H7-282140

### SUMMARY OF INVENTION

### Technical Problem

In PATENT LITERATURE 1, a method of computing by considering each of a plurality of regions, for example, as one process is conceivable for realization of supply adjustment through the plurality of regions. However, if the regions are defined on a country-by-country basis, the scale of the problem is so large that the computation time is enormously long.

An object of the present invention is to reduce the computation time in interregional plan adjustment.

### Solution to Problem

The following is a typical means included in the present application to solve the above-described problem.

An interregional supply adjustment device having a storage unit storing an amount of supply and an amount in a sales plan of each of items in regions, including an amount of production, an amount of stock and an amount of work-in-process, and adjustment permission information indicating a second region permitted to perform supply adjustment for a first region when an item out of stock occurs in a sales plan in the first region, the device including:

a first function of obtaining from the storage unit an amount of supply and an amount in the sales plan in the first region and determining a deficiency of an item out of stock such that the amount of supply is smaller than the amount in the sales plan;

a second function of identifying from the storage unit the second region for the item out of stock; and

a third function of producing, from a surplus in the second region, the amount of production, the amount of stock and the amount of work-in-process in the first region, supply adjustment information including the item supplied from the second region to the first region in supply adjustment and an amount of supply adjustment.

### Advantageous Effect of Invention

According to the present invention, the computation time in interregional plan adjustment can be reduced.

### BRIEF DESCRIPTION OF DRAWINGS

FIG. 1 is a diagram of a configuration of an interregional supply adjustment device.

FIG. 2 is a diagram showing item composition information.

FIG. 3 is a diagram showing regions, bases and a relationship in terms of transfer of items among the bases.

FIG. 4 is a diagram showing base information.

FIG. 5 is a diagram showing stock and work-in-process information.

FIG. 6 is a diagram showing supply path information.

FIG. 7 is a diagram showing production information.

FIG. 8 is a diagram showing processing capacity information.

FIG. 9 is a diagram showing sales plan information.

FIG. 10 is a diagram showing adjustment permission information.

FIG. 11 is a flowchart of processing for producing supply adjustment information.

FIG. 12 is a flowchart of processing for computing an amount of supply adjustment.

FIG. 13 is a diagram showing supply adjustment information.

FIG. 14 is a diagram showing an example of a display on a display device in the interregional supply adjustment device.

FIG. 15 is a diagram of a configuration of hardware of the interregional supply adjustment device.

### DESCRIPTION OF EMBODIMENTS

An embodiment of an interregional supply adjustment device will be described below.

### Embodiment 1

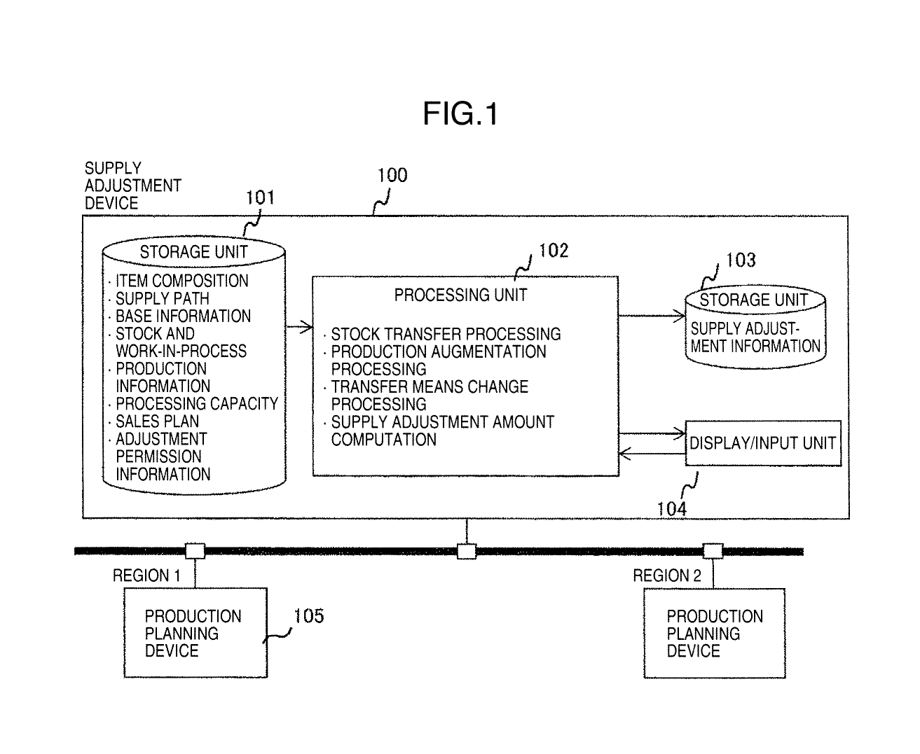

FIG. 1 shows a basic configuration of an interregional supply adjustment device 100. The interregional supply adjustment device 100 includes a storage unit 101, a processing unit 102, a storage unit 103 and a display/input unit 104.

The processing unit 102 performs interregional supply adjustment processing by using information stored in the storage unit 101, and stores supply adjustment information in the storage unit 103. The processing unit 102 also connects, if necessary, to a production planning device 105 to receive production plan information produced from one of regions and to transmit a reproduction request.

Information stored in the storage unit 101 will be described. The storage unit 101 stores item composition information, information on supply paths between bases, base information, stock and work-in-process information, production information, processing capacity information, sales plan information and adjustment permission information.

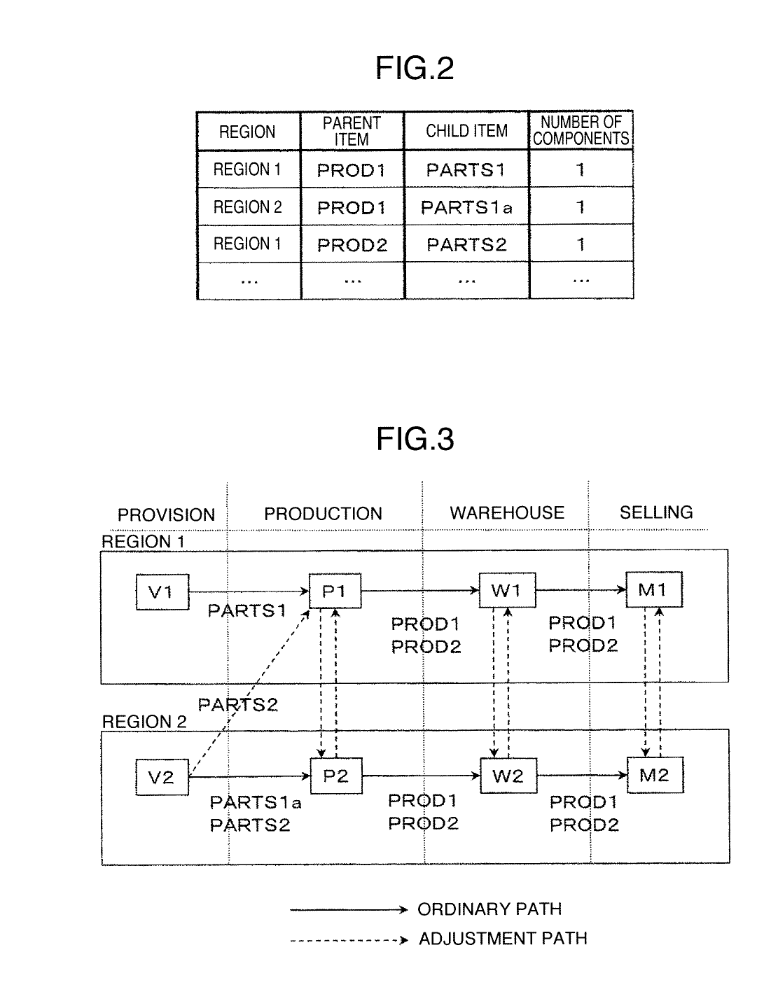

FIG. 2 shows an example of item composition information. An item composition shows, with respect to each of products, a compositional relationship between a parent item (product) and child items (parts). The item composition in this example is constituted of a parent item, child items constituting the parent item and the number of child items constituting the parent item.

FIG. 3 shows an example of information on supply paths between bases. It can be understood that a provision base V1, a production base P1, a warehouse base W1 and a selling base M1 exist in a region 1, and a provision base V2, a production base P2, a warehouse base W2 and a selling base M2 exist in a region 2. An ordinary path in each region through which a parent item and a child item are transported in order of the provision base, the production base, the warehouse base and the selling base and an ordinary path between the regions through which a child item is flowed from the provision base V2 in the region 2 to the production base P1 in the region 1 are set. Adjustment paths are also set in a case where supply through some of the ordinary paths is impossible. In this example, an adjustment path from the provision base V2 in the region 2 to the production base P1 in the region 1, a mutual adjustment path between the production base 1 in the region 1 and the production base P2 in the region 2, a mutual adjustment path between the warehouse base W1 in the region 1 and the warehouse base W2 in the region 2 and a mutual adjustment path between the sales base M1 in the region 1 and the sales base M2 in the region 2 are set.

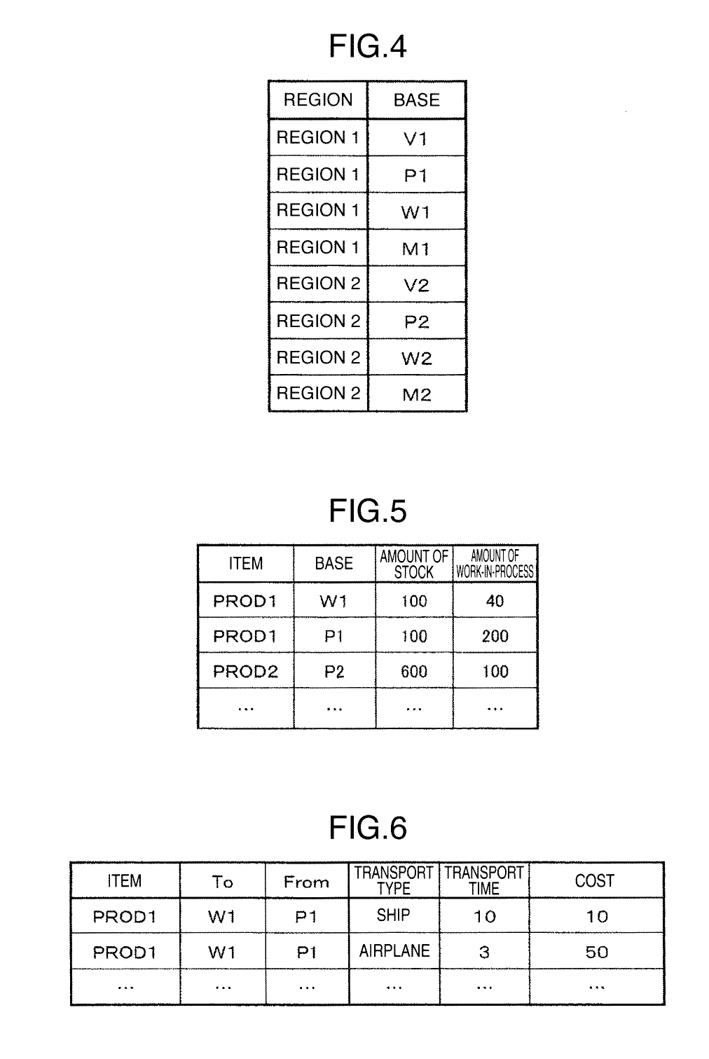

FIG. 4 shows an example of information on the bases in the regions.

FIG. 5 shows an example of stock and work-in-process information. The stock and work-in-process information includes an item, a base, an amount of stock and an amount of work-in-process.

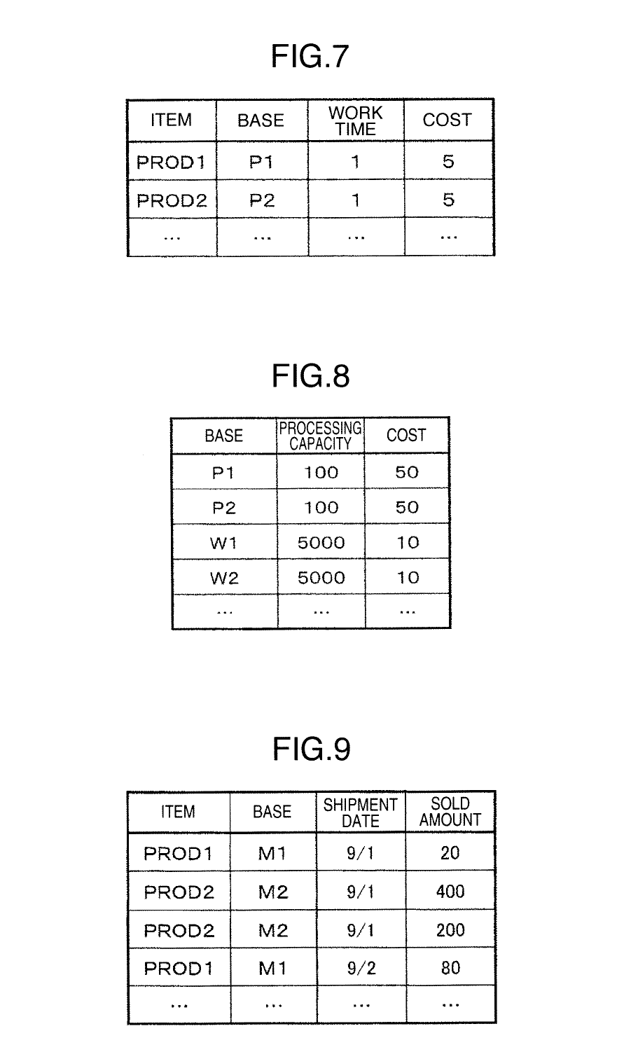

FIG. 6 shows an example of supply path information. The supply path information in this example includes an item, a base “To” as a supply destination, a base “From” as a supply source, a sort of transportation as a sort of transport means, a transport time and a cost. From the first line in this example, it can be understood that a time of 10 and a cost of 10 per unit are required in the case of supply from the base P1 to the base W1 by a ship. “Cost” is not required if not used for evaluation of any plan. The same can also be said with respect to FIGS. 7, 8, and 10 referred to below.

FIG. 7 shows an example of production information. The Production information includes, with respect to each base, an operation time and a cost per unit required for operations including a process of producing an item to be handled at the base. The production information in this example is constituted of an item, a base, an operation time and a cost.

FIG. 8 shows an example of processing capacity information. The processing capacity information indicates, with respect to each base, the upper limit value of the time during which an operation such as a production process can be performed. In this example, the processing capacity information is constituted of a base, a processing capacity and a cost. If the upper limit value varies day by day, the processing capacity may be entered on a daily basis.

FIG. 9 shows an example of sales plan information. The sales plan information indicates the time at which an item is sold from a selling base to a customer and the amount of the sold item. The sales plan information in this example is constituted of an item, a base, a shipment date and a sold amount. While data on shipments is formed by totalizing shipments in a daily cycle in this example, a time period longer or shorter than a day, e.g., a week, a month or the forenoon or afternoon may be set as a unit shipment period.

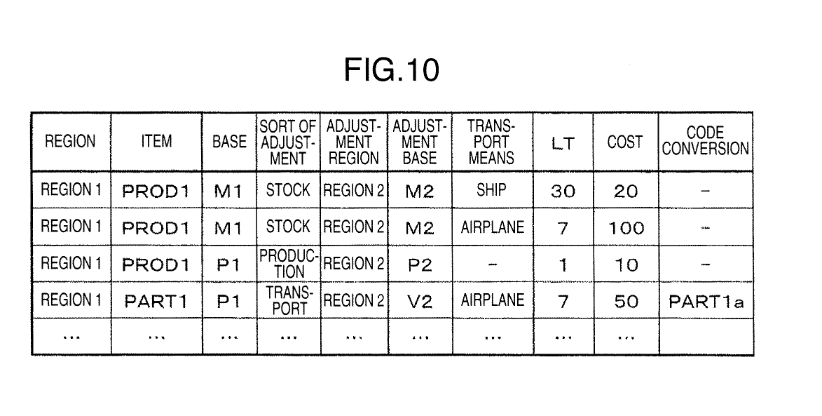

FIG. 10 shows an example of adjustment permission information. The adjustment permission information is information on items adjustable on a base-by-base basis. In this example, the adjustment permission information includes a region to receive a supply, an item to be supplied, a base to receive the supply, a sort of adjustment, a region (adjustment region) from which the supply can be given to the regions to receive the supply, means for transport to the adjustment region, a lead time (LT), a cost, and code conversion data to be used if the same item is differently named in the adjustment region.

The processing unit 102 reads out the above-described information from the storage unit 101 to a memory in the processing unit 102, computes a warehouse operation plan and a transport plan and outputs the plans to the storage unit 103.

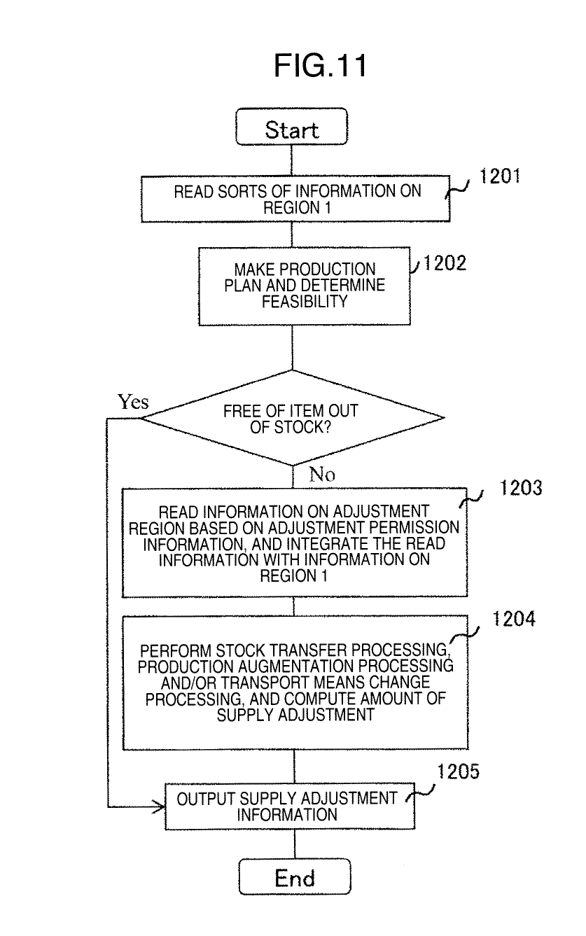

The interregional supply adjustment device 100 receives a production plan in the “region 1” from the production planning device 105 in the “region 1” and performs processing in steps shown in FIG. 11.

### <Step 1201>

The processing unit 102 reads information about the region 1 from the storage unit 101.

To be more specific, data on the “region 1” in the “region” data is first from the item composition information (FIG. 2) and the base information (FIG. 4). Subsequently, the stock and work-in-process information (FIG. 5) in which the “item” and the “base” of the “region” read out are entered, the production information (FIG. 6), the processing capacity information (FIG. 7) and the supply path information (FIG. 8) are successively read.

### <Step 1202>

The processing unit 102 sends the read data to the production planning device and receives the production plan in the “region 1” produced by the production planning device. The processing unit determines, on the basis of the received production plan in the “region 1”, whether or not a sales plan in the “region 1” can be met (whether or not the plan can be implemented without having any item out of stock).

If the sales plan in the “region 1” can be met (the plan can be implemented without having any item out of stock), the process moves to step 1205. If the sales plan in the “region 1” cannot be met (the plan cannot be implemented without having any item out of stock), the process moves to step 1203.

### <Step 1203>

The processing unit 102 performs computation to determine whether or not the item out of stock, responsible for failure to meet the sales plan in the region 1, can be supplied from another region set in advance.

To be more specific, the data associated with “region 1” entered in the region column in the adjustment permission information (FIG. 10) is read from the storage unit 101.

The “region 2” entered as an “adjustment region” is identified and the information on the identified “region 2” is read from the storage unit 101 and added to the data on the “region 1”. The sorts of information to be read are the same as the sorts of information with respect to the “region 1” read in step 1201.

However, the data associated with the sorts of adjustment “stock” and “transport” in the data read from the adjustment permission information (FIG. 10) is added to the supply path information, and the data associated with the sort of adjustment “production” is added to the production information. The data produced in step 1203 will hereinafter be referred to as “integral data” for convenience sake.

### <Step 1204>

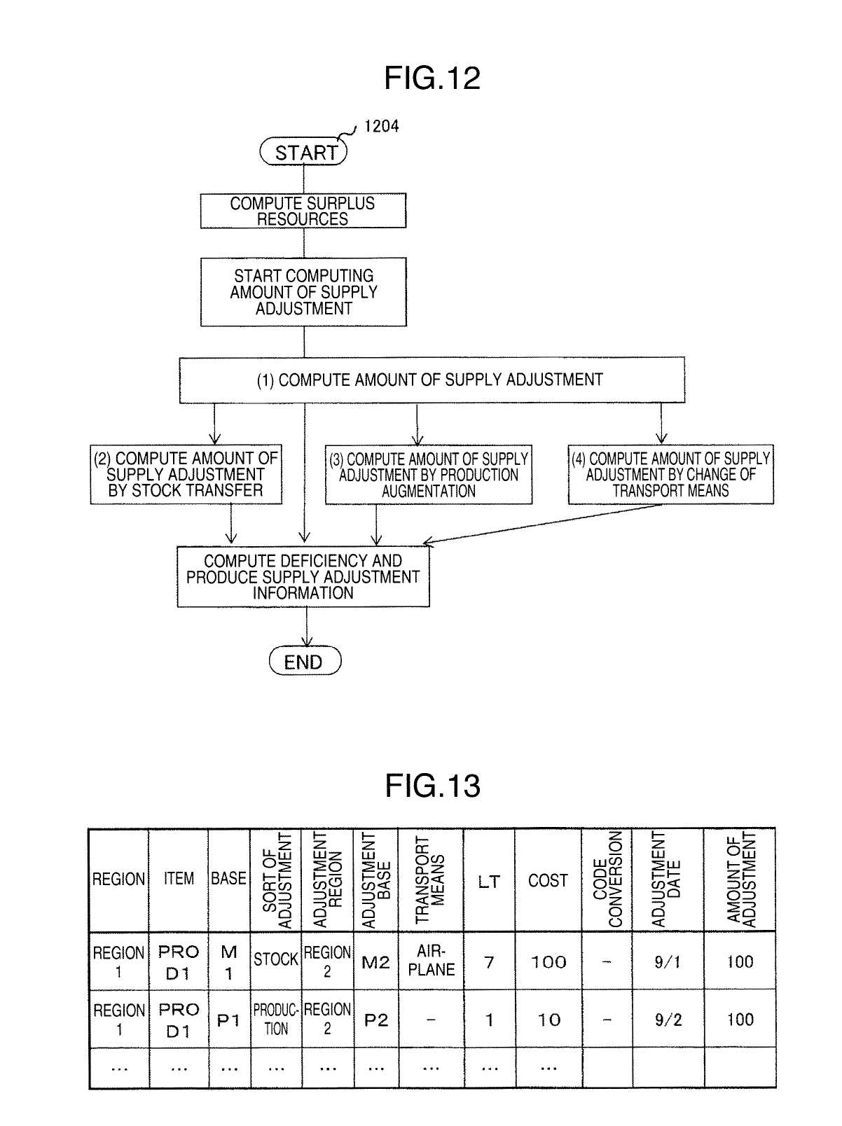

An amount of supply adjustment is computed by using the “integral data” produced in step 1203. FIG. 12 shows details of step 1204.

First, surplus resources in the adjustment region “region 2” are computed. This is a processing for clarifying amounts of resources (stock, production capacity) necessary for a sales plan in the “region 2” when determination is made as to whether or not a deficiency in the “region 1” can be supplied from the “region 2”.

If failure to follow the sales plan in the region concerned should be prevented, computation is performed by using only the surplus resources in supply adjustment amount computation for (1) to (4) below.

The surplus resources are computed by computing the product planning in step 1202 with respect to each adjustment region and by subtracting the sales plan and the production capacity, the amount of stock and the amount of work-in-process reserved for the plan from the production capacity data and stock and work-in-process data in the integral data.

Subsequently, an amount of supply adjustment from the adjustment region to the region 1 is computed by using the integral data. Four types of computation conditions: (1) all the sorts of adjustment in the adjustment permission information; (2) only transfer of stock from a different region other than the first region to the second region; (3) only augmentation of the production in the second region; and (4) only change of means for transport from the second region to the first region and change of means for transport from a different region other than the first region to the second region are generated and at least one or more of the conditions are selected or determined in advance to be used for the computation.

Even computing only (1) enables obtaining an amount of supply adjustment. However, the computation conditions (2), (3) and (4) are provided because adjustments in other regions are made easier if the number of types of adjustment is reduced. In this example, computation of (1) is performed and one of (2) to (4) is thereafter selected and executed.

Any computation method for supply adjustment amount computation is not exclusively specified. However, the same method as that used in step 1202 is used since the structure of the integral data is constituted of data on the bases and the supply paths connecting the bases. Since computations of (1) to (4) are independent of each other, they may be simultaneously performed in parallel with each other.

After the completion of at least one of the computations of (1) to (4), a surplus in the “region 2” is computed. When a surplus exceeding the “deficiency in region 1” is secured, processing in step 1204 is ended even if the other computations are not completed, thus producing supply adjustment information.

If the surplus does not exceed the deficiency as a result of all the computations of (1) to (4), supply adjustment information is produced such that the deficiency is minimized.

FIG. 13 shows an example of supply adjustment information. The supply adjustment information is formed by adding adjustment dates and adjustment amounts to the adjustment permission information.

### <Step 1205>

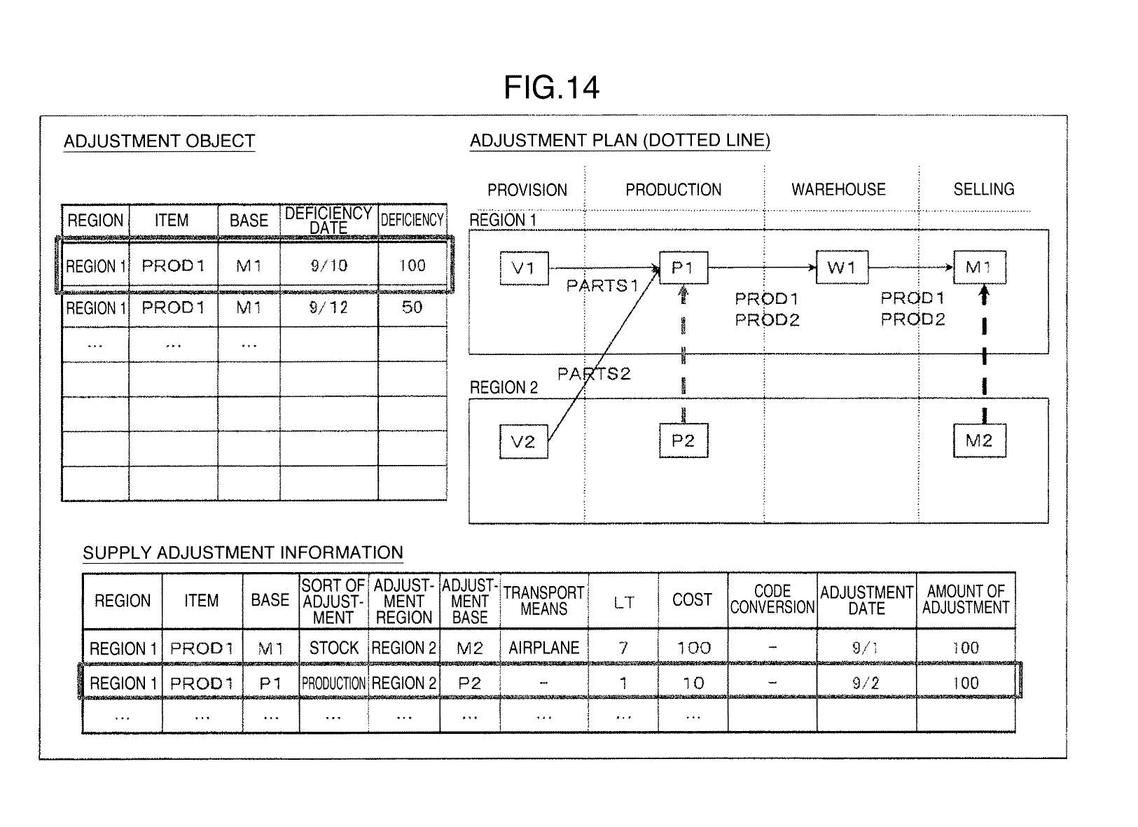

The supply adjustment information is output to the storage unit 103 and to the production planning device for the region 1. FIG. 14 shows an example of an output to display/input means in the production planning device. The deficiency and the supply adjustment information are indicated in areas for the adjustment object in a table and a diagram. When a row including the deficiency is selected, the supply adjustment information and an adjustment plan indicate in a highlighting manner how the deficiency was adjusted. It can be understood that, in the example shown in FIG. 14, the deficiency “9/10” of the item “PROD1” at the “base M1” in the “region 1” is adjusted by the production in the “region 2”.

Thus, even when a change in demand or supply which cannot be solved in a region occurs, a supply adjustment plan covering a different region can be speedily obtained.

### [Example of Production Planning Device]

While details of the production planning device are omitted in the above description of the embodiment because of the existence of well-known arts using MRP or linear programming, a production planning system using MRP in JP-A-H7-282140 is known as a well-known art using MRP for example. If this system is used in the present embodiment, sales plan information in the present embodiment is put in the “completed schedule” in [0032] of this publication. “Product names (final items) in production request information corresponding to order numbers” in [0032] of this publication correspond to items in the present embodiment, and the “total required amounts of the final items and the completion dates” in [0032] correspond to amounts of sales and shipment dates in the present embodiment. Order numbers used in JP-A-H7-282140 are not indispensable in the case of the present embodiment. However, serial numbers (1, 2, 3, . . . ) may be attached to lines in a sales plan as order numbers. Other sorts of information are such that “shops belonging to the most downstream group” in [0033] correspond to bases in a sales plan; an “amount of stock” corresponds to an “amount of stock” in stock and work-in-process information; an “amount of completion work” in [0034] corresponds to the product of multiplication of a work time in production information by an amount of production; and “production capacity” in [0035] corresponds to “processing capacity” in processing capacity information.

### [Hardware Configuration]

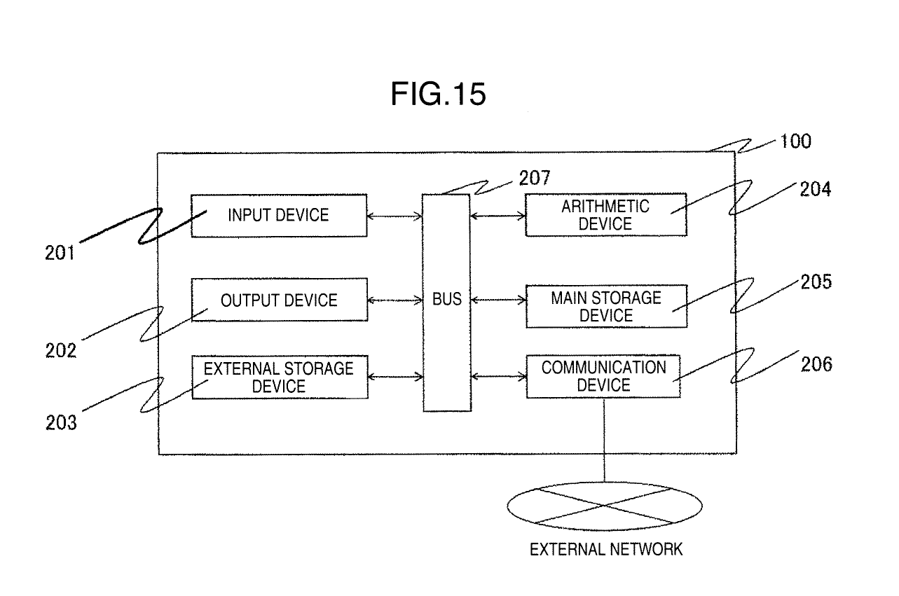

FIG. 15 shows an example of a hardware configuration of the interregional supply adjustment device 100. In the present embodiment, the interregional supply adjustment device 100 is, for example, an information processor such as a personal computer, a workstation or a server unit.

That is, the interregional supply adjustment device 100 has a configuration including an input device 201, an output device 202, an external storage device 203, an arithmetic device 204, a main storage device 205, a communication device 206 and a bus 207 through which these devices are connected to each other.

The input device 201 is a device such as a keyboard and a mouse, a touch pen or any other pointing device for receiving an input. The output device 202 is a device such as a display for producing a display. The external storage device 203 is a nonvolatile memory device such as a hard disk device or a flash memory. The arithmetic device 204 is an arithmetic device such as a central processing unit (CPU). The main storage device 205 is a memory device such as a random access memory (RAM). The communication device 206 is a wireless communication device which performs wireless communication through an antenna or a wired communication device which performs wired communication through a network cable. A storage unit of the interregional supply adjustment device 100 is realized by the main storage device 205 or the external storage device 203 of the interregional supply adjustment device 100.

Also, an input unit, a processing unit and an output unit of the interregional supply adjustment device 100 are realized by a program which causes the arithmetic device 204 in the interregional supply adjustment device 100 to perform processing. This program is stored in the main storage device 205 or the external storage device 203, is loaded on the main storage device 205 when executed, and is executed by the arithmetic device 204. The interregional supply adjustment device 100 may have the communication device 206 according to one's need and may transmit or receive information through the communication device 206. For example, a form of implementation is conceivable which has units separated on a hardware/function basis, such that a storage unit relating to provision, production and selling in any one of regions is incorporated in a device managed in the region, and a processing unit which computes and outputs computation results is incorporated in a device managed by an information department.

Part or the whole of each of the above-described components, functions, processing units, processing means, and so on may be implemented in hardware form, for example, by being designed in a semiconductor circuit. Each of the above-described components, functions, and so on may alternatively be implemented in software form by a processor interpreting and executing a program for realizing each function. Information including the program for realizing each function, tables and files can be placed on a recording device such as a memory, a hard disk or a solid state drive (SSD) or on a recording medium such as an IC card, an SD card or a DVD.

### REFERENCE SIGNS LIST

100 Interregional supply adjustment device
101 Storage unit
102 Processing unit
103 Storage unit
104 Display/input unit
1201 to 1205 Supply adjustment processing step

1. An interregional supply adjustment device comprising:
a storage unit configured to store an amount of supply and an amount in a sales plan of each of items in regions, including an amount of production, an amount of stock and an amount of work-in-process, and adjustment permission information indicating a second region permitted to perform supply adjustment for a first region when an item out of stock occurs in a sales plan in the first region,
wherein the device is further configured to perform
a first function of obtaining from the storage unit an amount of supply and an amount in the sales plan in the first region and determining a deficiency of an item out of stock such that the amount of supply is smaller than the amount in the sales plan;
a second function of identifying from the storage unit the second region for the item out of stock; and
a third function of producing, from a surplus in the second region, the amount of production, the amount of stock and the amount of work-in-process in the first region, supply adjustment information including the item supplied from the second region to the first region in supply adjustment and an amount of supply adjustment.

2. The interregional supply adjustment device according to claim 1, wherein the third function includes at least one of
moving stock from a region other than the first region to the second region;
augmenting the production in the second; and
changing means for transport from the second region to the first region and changing means for transport from a region other than the first region to the second region, and the third function includes recomputing the surplus in the second region.

3. The interregional supply adjustment device according to claim 1, wherein the supply adjustment information includes a supply adjustment period.

4. The interregional supply adjustment device according to claim 3, wherein the storage unit further comprises:
item composition information;
supply path information indicating means for transfer between bases and transfer time with respect to each item;
base information indicating bases in the regions;
stock and work-in-process information indicating the amount of stock and the amount of work-in-process of each item on a base-by-base basis;
production information indicating production time for each item on a base-by-base basis; and
processing capacity information indicating processing capacity on a base-by-base basis,
wherein by the first function and the third function uses one or more of said item composition information, said supply path information, said base information, said stock and work-in-process information, said production information, and said processing capacity information in computing the amount of production, the amount of stock and the amount of work-in-process in the first region and the surplus in the second region.

5. A non-transitory computer readable medium upon which is embodied a sequence of programmed instructions which, when executed by an information processor, cause said information processor to perform interregional supply adjustment steps comprising:
storing an amount of supply and an amount in a sales plan of each of items in regions, including an amount of production, an amount of stock and an amount of work-in-process, and adjustment permission information indicating a second region permitted to perform supply adjustment for a first region when an item out of stock occurs in a sales plan in the first region;
obtaining from the storage unit an amount of supply and an amount in the sales plan in the first region and determining a deficiency of an item out of stock such that the amount of supply is smaller than the amount in the sales plan;
identifying from the storage unit the second region for the item out of stock; and
producing, from a surplus in the second region, the amount of production, the amount of stock and the amount of work-in-process in the first region, supply adjustment information including the item supplied from the second region to the first region in supply adjustment and an amount of supply adjustment.
